(19) United States
(12) Patent Application Publication
(10) Pub. No.: US 2024/0176362 A1
(43) Pub. Date: May 30, 2024

(54) ROBOT CLEANER AND LOCATION IDENTIFICATION METHOD THEREOF

(71) Applicant: Samsung Electronics Co., Ltd., Suwon-si (KR)

(72) Inventors: Jaeyoung JUNG, Suwon-si (KR); Heungryong OH, Suwon-si (KR)

(21) Appl. No.: 18/437,120

(22) Filed: Feb. 8, 2024

Related U.S. Application Data
(63) Continuation of application No. PCT/KR2022/009971, filed on Jul. 8, 2022.

(30) Foreign Application Priority Data
Aug. 24, 2021 (KR) 10-2021-0111906

(51) Int. Cl. G05D 1/247; A47L 9/28; G05D 1/661; G05D 105/10; G05D 107/40; G05D 111/30

(52) U.S. Cl. CPC G05D 1/247; A47L 9/2805; A47L 9/2873; A47L 9/2894; G05D 1/661; A47L 2201/022; G05D 2105/10; G05D 2107/40; G05D 2111/32

(57) ABSTRACT

A robot cleaner is disclosed. The robot cleaner comprises: a wireless communication module comprising wireless communication circuitry; a UWB communication module comprising UWB communication circuitry; and at least one processor, comprising processing circuitry, individually and/or collectively, configured to: identify whether at least one electronic device capable of UWB communication and at least one electronic device capable of wireless communication are present in a space where the robot cleaner is located, and based on the presence of a first electronic device capable of UWB communication and a second electronic device capable of wireless communication being identified, identify a first distance between the first electronic device and the robot cleaner using the UWB communication module, identify a second distance between the second electronic device and the robot cleaner using the wireless communication module, identify a third distance between a charging station, located in the space and capable of UWB communication, and the robot cleaner using the UWB communication module, and identify the location of the robot cleaner based on the first distance, the second distance, the third distance, the location of the first electronic device, the location of the second electronic device, and the location of the charging station, wherein wireless communication includes a communication scheme different from UWB communication.

### CROSS-REFERENCE TO RELATED APPLICATIONS

This application is a continuation of International Application No. PCT/KR2022/009971 designating the United States, filed on Jul. 8, 2022, in the Korean Intellectual Property Receiving Office and claiming priority to Korean Patent Application No. 10-2021-0111906, filed on Aug. 24, 2021, in the Korean Intellectual Property Office, the disclosures of each of which are incorporated by reference herein in their entireties.

### BACKGROUND

### Field

The disclosure relates to a robot cleaner and a location identification method thereof and, for example, to a robot cleaner for identifying a location of a robot cleaner and a location identification method thereof.

### Description of Related Art

Generally, a robot has been developed with an industrial use and is widely used in various industrial sites. Recently, a field using a robot is further expanded, and a robot is used not only in a medical field, a space aviation field, but also in a general household.

A representative robot used at home is a robot cleaner. The robot cleaner performs a function of sucking and cleaning foreign substances such as dust while autonomously travelling an indoor space at home.

Meanwhile, when the robot cleaner is caught or stuck in an obstacle while driving, a user has to move the robot cleaner to move the robot cleaner to escape from the obstacle. As described above, when the location of the robot cleaner is changed, particularly, in the case of a robot cleaner that does not include a light detection and ranging (LiDAR) sensor, there is a difficulty in identifying the location of the robot cleaner and the location of the charging station on the map, and accordingly, there is a problem in that the robot cleaner has a difficulty in cleaning a remaining area or in returning to the charging station.

### SUMMARY

Embodiments of the disclosure address the above-mentioned problems and provide a robot cleaner that may identify a location of a robot cleaner using various communication modules and a location identification method thereof.

A robot cleaner according to an example embodiment includes: a wireless communication module comprising communication circuitry, a ultra wideband (UWB) communication module comprising UWB circuitry, and at least one processor, comprising processing circuitry, individually and/or collectively, configured to: identify whether at least one electronic device capable of UWB communication and at least one electronic device capable of wireless communication are present in a space where the robot cleaner is located, based on the presence of a first electronic device capable of UWB communication and a second electronic device capable of wireless communication being identified, identify a first distance between the first electronic device and the robot cleaner using the UWB communication module, identify a second distance between the second electronic device and the robot cleaner using the wireless communication module, identify a third distance between a charging station, located in the space and capable of UWB communication, and the robot cleaner using the UWB communication module, and identify the location of the robot cleaner based on the first distance, the second distance, the third distance, the location of the first electronic device, the location of the second electronic device, and the location of the charging station, wherein the wireless communication is a communication scheme different from the UWB communication.

The wireless communication may include a Bluetooth communication.

At least one processor, individually and/or collectively, is configured to, based on the first electronic device being an electronic device capable of the UWB communication and being installed at a fixed location in the place, identify that the first electronic device is an electronic device capable of the UWB communication, and based on the second electronic device being an electronic device capable of the wireless communication and installed at a fixed location in the place, identify that the second electronic device is an electronic device capable of the wireless communication.

At least one processor, individually and/or collectively, is configured to, based on identifying that at least two electronic devices capable of the wireless communication are present, identify a distance between each of the at least two electronic devices and the robot cleaner using the wireless communication module, and identify the location of the robot cleaner based on the distance between each of the at least two electronic devices and the robot cleaner, the third distance, locations of each of the at least two electronic devices, and the location of the charging station.

At least one processor, individually and/or collectively, is configured to, based on identifying that the electronic device capable of the wireless communication is not present and at least two electronic devices capable of the UWB communication being present, identify distance between the at least two electronic devices and the robot cleaner using the UWB communication module, and identify the location of the robot cleaner based on the distance between each of the at least two electronic devices and the robot cleaner, the third distance, locations of each of the at least two electronic devices, and the location of the charging station.

At least one processor, individually and/or collectively, is configured to, based on identifying that the electronic device capable of the wireless communication is not present, and a third electronic device capable of angle of arrival (AOA) measurement using the UWB communication is present, identify the location of the robot cleaner based on distance between the third electronic device and the robot cleaner, the direction of the robot cleaner and the direction of the charging station with reference to the third electronic device.

The robot cleaner according to an example embodiment may further include a sensor, and at least one processor, individually and/or collectively, is configured to, based on identifying that the location of the robot cleaner is moved based on data obtained by the sensor, identify whether the electronic device capable of the UWB communication and the electronic device capable of wireless communication are present.

At least one processor, individually and/or collectively, is configured to, based on identifying that the location of the charging station is changed, identify distances between the charging station and the robot cleaner using the UWB communication module while the robot cleaner is located at three different locations, and identify the location of the charging station based on the identified distances, and the three different locations may be determined based on accuracy of the distance between the robot cleaner and the charging station identified based on the UWB communication.

A location identification method of a robot cleaner including a ultra wideband (UWB) communication module and a wireless communication module includes: identifying whether at least one electronic device capable of UWB communication and at least one electronic device capable of wireless communication are present in a space where the robot cleaner is located, based on the presence of a first electronic device capable of UWB communication and a second electronic device capable of wireless communication being identified, identifying a first distance between the first electronic device and the robot cleaner using the UWB communication module, identifying a second distance between the second electronic device and the robot cleaner using the wireless communication module, identifying a third distance between a charging station, located in the space and capable of UWB communication, and the robot cleaner using the UWB communication module, and identifying the location of the robot cleaner based on the first distance, the second distance, the third distance, the location of the first electronic device, the location of the second electronic device, and the location of the charging station, wherein the wireless communication is a communication scheme different from the UWB communication.

The wireless communication may include a Bluetooth communication.

The identifying whether at least one electronic device capable of UWB communication and at least one electronic device capable of wireless communication are present may include, based on the first electronic device being an electronic device capable of the UWB communication and installed at a fixed location in the place, identifying that the first electronic device is an electronic device capable of the UWB communication, and based on the second electronic device being an electronic device capable of the wireless communication and installed at a fixed location in the place, identifying that the second electronic device is an electronic device capable of the wireless communication.

The method may further include, based on identifying that at least two electronic devices capable of the wireless communication are present, identifying a distance between each of the at least two electronic devices and the robot cleaner using the wireless communication module; and identifying the location of the robot cleaner based on the distance between each of the at least two electronic devices and the robot cleaner, the third distance, locations of each of the at least two electronic devices, and the location of the charging station.

The method may further include, based on identifying that the electronic device capable of the wireless communication is not present and at least two electronic devices capable of the UWB communication are present, identifying distance between the at least two electronic devices and the robot cleaner using the UWB communication module; and identifying the location of the robot cleaner based on distance between each of the at least two electronic devices and the robot cleaner, the third distance, locations of each of the at least two electronic devices, and the location of the charging station.

The method may further include, based on identifying that the electronic device capable of the wireless communication is not present, and a third electronic device capable of angle of arrival (AOA) measurement using the UWB communication is present, identifying the location of the robot cleaner based on distance between the third electronic device and the robot cleaner, the direction of the robot cleaner and the direction of the charging station with reference to the third electronic device.

The identifying whether at least one electronic device capable of UWB communication and at least one electronic device capable of wireless communication are present may include, based on identifying that the location of the robot cleaner is moved, identifying whether the electronic device capable of the UWB communication and the electronic device capable of wireless communication are present.

In addition, an example method may include, based on identifying that the location of the charging station is changed, identifying distances between the charging station and the robot cleaner using the UWB communication module while the robot cleaner is located at three different locations, and identifying the location of the charging station based on the identified distances, and the three different locations may be determined based on accuracy of the distance between the robot cleaner and the charging station identified based on the UWB communication.

According to various example embodiments of the disclosure, the convenience of a user may be improved in that a robot cleaner may identify a location of a robot cleaner as well as a charging station, and may perform an operation accordingly.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating an example robot cleaner according to various embodiments;

FIG. 2 is a block diagram illustrating an example configuration of a robot cleaner according to various embodiments;

FIGS. 3, 4, 5, 6, 7, 8, 9 and 10 include flowcharts and diagrams illustrating an example method for identifying a location of a robot cleaner according to various embodiments;

FIGS. 11 and 12 include a flowchart and diagram illustrating an example method for identifying a charging station location according to various embodiments;

FIG. 13 is a block diagram illustrating an example configuration of a robot cleaner according to various embodiments; and

FIG. 14 is a flowchart illustrating an example method for identifying a location of a robot cleaner according to various embodiments.

### DETAILED DESCRIPTION

Hereinafter, various example embodiments of the disclosure will be described in greater detail with reference to the accompanying drawings. However, it may be understood that the disclosure is not limited to the various embodiments described hereinafter, but also includes various modifications, equivalents, and/or alternatives to these embodiments. In relation to explanation of the drawings, similar drawing reference numerals may be used for similar elements.

In the following description, a detailed description of the related art may be omitted when it is determined that such description may obscure the gist of the disclosure.

In addition, the following example embodiments may be combined and modified in many different forms, and the scope of the technical spirit of the disclosure is not limited to the following examples. Rather, the example embodiments are provided to convey the technical spirit to those skilled in the art.

The terms used herein are to describe certain embodiments and are not intended to limit the scope of claims. A singular expression includes a plural expression unless otherwise specified.

In this disclosure, the expressions “have,” “may have,” “including,” or “may include” may be used to denote the presence of a feature (e.g., elements such as a numerical value, a function, an operation, or a part), and do not exclude the presence of additional features.

In this disclosure, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, or (3) at least one A and at least one B together.

In the disclosure, the terms “first,” “second,” and so forth are used to describe diverse elements regardless of their order and/or importance, and to discriminate one element from other elements, but are not limited to the corresponding elements.

If it is described that a certain element (e.g., first element) is “operatively or communicatively coupled with/to” or is “connected to” another element (e.g., second element), it should be understood that the certain element may be connected to the other element directly or through still another element (e.g., third element).

On the other hand, if it is described that a certain element (e.g., first element) is “directly coupled to” or “directly connected to” another element (e.g., second element), it may be understood that there is no element (e.g., third element) between the certain element and the another element.

Herein, the expression “configured to” may be used interchangeably with, for example, “suitable for,” “having the capacity to,” “designed to,” “adapted to,” “made to,” or “capable of.” The expression “configured to” does not necessarily mean “specifically designed to” in a hardware sense.

Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processing unit (CPU) or application processor (AP)) that can perform the corresponding actions by executing one or more software programs stored in the memory device.

The term such as “module,” or “unit,” “part may refer to an element that performs at least one function or operation, and such element may be implemented as hardware or software, or a combination of hardware and software. Further, except for when each of a plurality of “modules”, “units” to be realized in an individual hardware, the components may be integrated in at least one module or chip and be realized in at least one processor.

It is understood that various elements and regions in the figures may be shown out of scale. Accordingly, the scope of the disclosure is not limited by the relative sizes or spacing drawn from the accompanying drawings.

Hereinafter, with reference to the attached drawings, various example embodiments will be described in greater detail.

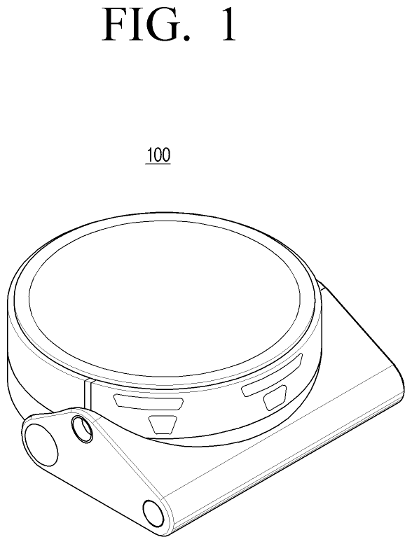

FIG. 1 is a perspective view illustrating an example robot cleaner according to various embodiments.

Referring to FIG. 1, a robot cleaner 100 may perform a cleaning operation while moving (or traveling) in a space where the robot cleaner 100 is located.

The space may include various indoor spaces where the robot cleaner 100 may move, such as a house, an office, a hotel, a plant, a store, or the like.

In addition, the cleaning operation may refer, for example, to suction of foreign substances such as dirt and dust existing on the floor surface by the robot cleaner 100. For this, the robot cleaner 100 may include a cleaning device (e.g., a cleaning tool) for suctioning foreign substances. The cleaning device may include a brush rotatably installed to collect foreign substances, and may generate a suction force through a motor or the like to suction foreign substances from the bottom surface. At this time, the suctioned foreign substances may be accommodated in a dust box provided in the robot cleaner 100.

The robot cleaner 100 may generate a map about the space where the robot cleaner 100 is located and may move using the map.

For example, the robot cleaner 100 may move in a space, obtain data through various sensors (for example, a camera, a gyro sensor, etc.) of the robot cleaner 100 while moving, and may generate a map for a space in which the robot cleaner 100 is located based on the data. In this case, the robot cleaner 100 may use simultaneous localization and mapping (SLAM).

According to an embodiment of the disclosure, the robot cleaner 100 may, even if the location of the robot cleaner 100 is changed, identify the location of the robot cleaner 100 using various communication modules, which will be described in greater detail below.

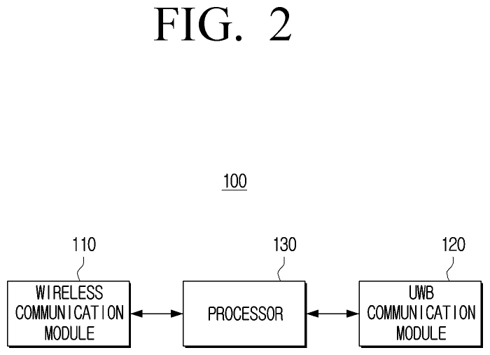

FIG. 2 is a block diagram illustrating an example configuration of a robot cleaner according to various embodiments.

Referring to FIG. 2, the robot cleaner 100 may include a wireless communication module (e.g., including wireless communication circuitry) 110, ultra wideband (UWB) communication module (e.g., including UWB circuitry) 120, and a processor (e.g., including processing circuitry) 130.

The wireless communication module 110 may include various wireless processing circuitry and perform wireless communication with an electronic device.

The wireless communication may include Bluetooth communication. The wireless communication module 110 may include a Bluetooth communication module including various circuitry for performing communication using a Bluetooth communication scheme.

In The wireless communication may include Wi-Fi communication. The wireless communication module 110 may include a Wi-Fi communication module including various circuitry to perform communication using a Wi-Fi communication scheme.

In addition, the wireless communication module 110 may include infrared ray (IR) communication module including various circuitry to perform communication using the IR communication scheme.

The UWB communication module 120 may be a module to perform communication with an electronic device through the UWB communication scheme. In this case, the UWB communication module 120 may include at least one antenna for UWB communication.

The processor 130 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. For example, the processor 130 may control the overall operation of the robot cleaner 100. For example, the processor 130 is connected to the configuration of the electronic device 100 including the wireless communication module 110 and the UWB communication module 120, and executes at least one instruction stored in the memory of the robot cleaner 100 to control the overall operation of the robot cleaner 100. In this case, the processor 130 may be implemented as one processor 130, and may be implemented as a plurality of processors 130. Meanwhile, in the disclosure, the term processor 130 may include a central processing unit (CPU).

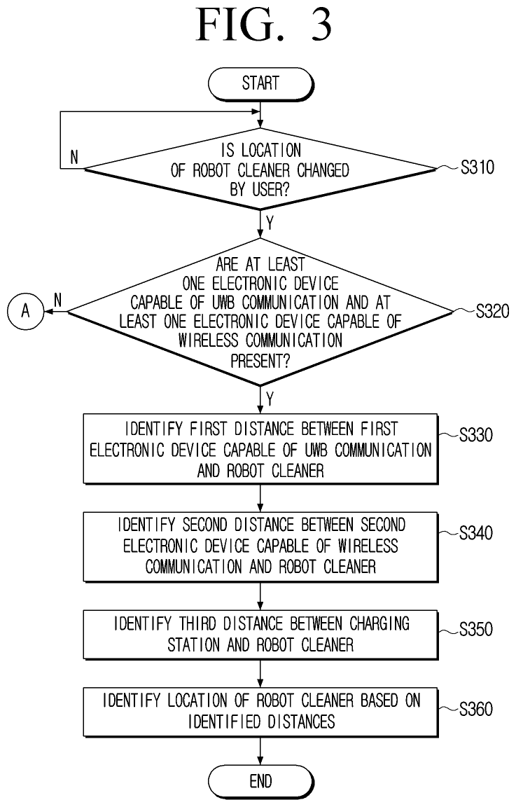

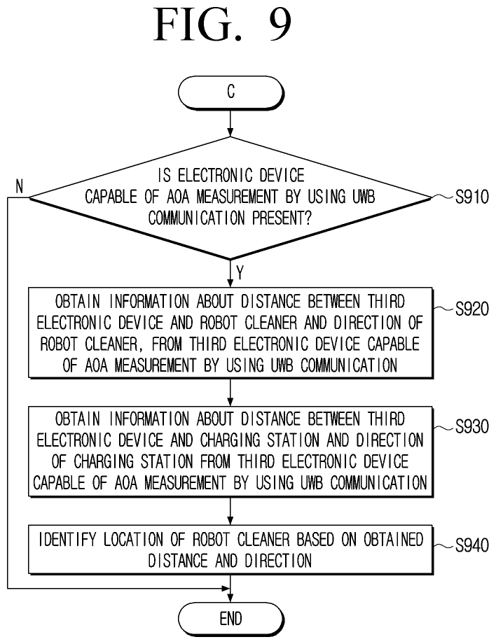

For example, the processor 130 may identify a location of the robot cleaner 100 and hereinafter with reference to FIGS. 3 to 10 attached hereinafter, a detailed description will be provided.

With reference to FIG. 3, the processor 130 may identify whether a location of the robot cleaner 100 is changed (e.g., by a user) in operation S310.

For this, the robot cleaner 100 may include a sensor. The sensor may include a contact sensor, a cliff detection sensor, an encoder, or the like.

The contact sensor may detect a contact between a wheel and a ground of the robot cleaner 100. Accordingly, the processor 130 may identify whether a wheel of the robot cleaner 100 is in contact with the ground or a state in which contact of the wheel of the robot cleaner 100 with the ground is released, based on data received from the contact sensor. In this case, when the contact of the wheel of the robot cleaner 100 with the ground is released, the processor 130 may identify that the location of the robot cleaner 100 is changed by the user.

A cliff detection sensor may detect a cliff at a lower part of a robot cleaner 100. The cliff detection sensor irradiates light toward the lower side of the robot cleaner 100, and may detect the distance from the ground existing on the lower side of the robot cleaner 100 using the time at which the irradiated light is reflected and received at the robot cleaner 100. Accordingly, the processor 130 may identify that the location of the robot cleaner 100 is changed by the user when it is determined that the robot cleaner 100 is spaced apart from the ground by a predetermined distance or more, based on data received from the cliff detection sensor.

The encoder may detect the number of rotations of the wheel of the robot cleaner 100.

The processor 130 may identify that the location of the robot cleaner 100 has been changed by the user when it is identified that the wheel rotates in a state in which an actuator such as a motor is not driven, based on the data received from the encoder.

As another example, the processor 130 may identify that the location of the robot cleaner 100 is changed by the user when it is identified that the actuator is driven but the wheel does not rotate, based on the data received from the encoder, since that the actuator is driven but the wheel does not rotate may show that the robot cleaner 100 is caught or trapped in the obstacle, in which case the user is likely to move the robot cleaner 100 from the obstacle.

Accordingly, the processor 130 may identify whether the location of the robot cleaner 100 is changed by a user based on the data obtained by a sensor.

If it is identified that the location of the robot cleaner 100 is changed by the user based on the data obtained by the sensor, the processor 130 may identify that there are an electronic device capable of the UWB communication and an electronic device capable of wireless communication in operation S320.

The processor 130 may activate the UWB communication module 120 of the robot cleaner 100. In addition, the processor 130 may activate the wireless communication module 110 of the robot cleaner 100.

In addition, the processor 130 may activate a UWB communication module of the charging station. Here, the charging station may be a device for charging the robot cleaner 100. For example, the charging station may be installed in a space (e.g., a house) such as the robot cleaner 100, and when the robot cleaner 100 is docked, power may be supplied to the robot cleaner 100 to charge a battery of the robot cleaner 100. In addition, the charging station may include a UWB communication module including at least one antenna. In addition, according to an embodiment, the charging station may further include at least one of an IR communication module, a Wi-Fi communication module, and a Bluetooth communication module.

The processor 130 may transmit a control command to activate the UWB communication module of the charging station to the charging station through a server (not shown).

The server (not shown) may register various electronic devices installed or present in a space where the robot cleaner 100 is located and may perform a function to manage the devices.

For example, a user may register various electronic devices (for example, an Internet of Things (IOT) device, etc.) present in a space in which the robot cleaner 100 is located, in a server (not shown) using an application installed in a mobile device such as a cellular phone, a tablet PC, or the like. In this case, the electronic device may be registered for each user account. Here, the electronic device may include various home appliances such as a robot cleaner, a charging station, an AI speaker, a refrigerator, an air conditioner, and a TV as well as a mobile device such as a mobile phone and a tablet PC.

In this case, a server (not shown) may communicate with an electronic device to transmit and receive various data. When a user command for controlling the electronic device is received from the mobile device, the server (not shown) may transmit a control command for controlling the electronic device to the electronic device according to the user command.

Accordingly, the processor 130 may transmit, to a server (not shown), a control command for activating the UWB communication module of the charging station using the Wi-Fi communication module. When a control command is received from a server (not shown) through a Wi-Fi communication module, the charging station may activate a UWB communication module of the charging station.

Meanwhile, in the example above, it is described that the robot cleaner 100 activates the UWB communication module of the charging station through a server (not shown), but this is merely an example.

As another example, if the charging station includes a Bluetooth communication module, the processor 130 may transmit a control command to active the UWB communication module of the charging station to the charging station using a Bluetooth communication module. As a still another example, when the robot cleaner 100 and the charging station include the IR communication module, the processor 130 may transmit the control command to activate the UWB communication module of the charging station to the charging station using the IR communication module.

In the meantime, even if not receiving a separate control command from the robot cleaner 100, the charging station may activate the UWB communication module of the charging station. For example, if the robot cleaner 100 docked to the charging station starts moving and docking is released from the charging station, the charging station may activate the UWB communication module.

As such, the UWB communication module of the charging station may be activated through various methods.

In the meantime, the aforementioned example is merely an example, and the UWB nodule of the robot cleaner 100 and the charging station may be activated when the power of the charging station is turned on or according to a separate user command. Meanwhile, the wireless communication module of the electronic device nay be activated when power is turned on or according to a separate user command.

In the meantime, the processor 130 may identify whether at least one electronic device capable of the UWB communication and at least one electronic device capable of wireless communication are present in a space where the robot cleaner 100 is located in operation S320.

The wireless communication may be a communication scheme different from the UWB communication. For example, wireless communication may be Bluetooth communication. For another example, the wireless communication may be Wi-Fi communication.

For this, the processor 130 may obtain information about an electronic device from a server (not shown) through the Wi-Fi communication module. In this case, the Wi-Fi communication module may communicate with a server (not shown) by accessing a network through an access point.

For example, when an electronic device is registered, a server (not shown) may obtain information related to an electronic device from a database (for example, a database including information about a specification of the electronic device) or a registered electronic device, and store the obtained information.

The information related to the electronic device may include device information like a type of an electronic device, a type of the communication modules installed in the electronic device (that is, information about a communication scheme available by the electronic device), the number of antennas, height of the antenna, or the like.

Accordingly, the processor 130 may obtain, from a server (not shown), information about the communication scheme available by the electronic device, the number of antennas, or the like, through the Wi-Fi communication module.

In addition, the processor 130, based on the obtained information, may determine whether any electronic device is a device capable of wireless communication (that is, whether the electronic device includes a wireless communication module (e.g., a Bluetooth communication module, a Wi-Fi communication module)), and which electronic device is capable of UWB communication (e.g., whether the electronic device includes a UWB communication module), or when the electronic device is capable of performing UWB communication, how many antennas are included.

In this case, an electronic device may be registered in a server (not shown) for each user account. Therefore, the processor 130 may determine the device capable of wireless communication, the device capable of the UWB communication among the electronic devices registered in the same account as the user account in which the robot cleaner 100 is registered, the number of antennas of the device capable of the UWB communication, or the like.

In the aforementioned example, it has been described that the processor 130 uses the information obtained through the server (not shown), but this is an example.

As another example, the processor 130 may use a UWB communication module or a wireless communication module. That is, the processor 130 may identify whether there is an electronic device capable of performing UWB communication or wireless communication around the robot cleaner 100 using a UWB communication module or a wireless communication module.

For this, the processor 130 may activate the UWB communication module or the wireless communication module of the electronic device using various communication methods.

For example, when the electronic devices include a Bluetooth communication module or an IR communication module, the processor 130 may transmit, to the electronic devices, a control command for activating the UWB communication module of the electronic devices using the Bluetooth communication module or the IR communication module. As another example, when the electronic devices include a UWB communication module or an IR communication module, the processor 130 may transmit a control command for activating the Bluetooth communication module of the electronic devices to the electronic devices using a UWB communication module or an IR communication module.

When it is identified that a first electronic device capable of UWB communication and a second electronic device capable of wireless communication present in a space in which the robot cleaner 100 is located in operation S320-Y, the processor 130 may identify a first distance between the first electronic device and the robot cleaner 100 using the UWB communication module 120 in operation S330, and may identify a second distance between the second electronic device and the robot cleaner 100 using the wireless communication module 110 in operation S340.

In this case, the processor 130 is configured to, based on the first electronic device being an electronic device capable of the UWB communication and installed at a fixed location in the place, identify that the first electronic device is an electronic device capable of the UWB communication. In addition, the processor 130 may, based on the second electronic device being an electronic device capable of the wireless communication and installed at a fixed location in the place, identify that the second electronic device is an electronic device capable of the wireless communication.

The electronic device installed at a fixed location may refer, for example, to an electronic device, not a mobile device. In this case, the processor 130 may identify whether the electronic device is a mobile device using the information about a type of the electronic device obtained from the server (not shown).

For example, it is assumed that an artificial intelligence (AI) speaker located in the living room of the house may perform UWB communication, and a refrigerator located in the kitchen of the house may perform Bluetooth communication. In this case, the processor 130 may determine that the AI speaker is an electronic device capable of UWB communication, and determine that the refrigerator is an electronic device capable of wireless communication.

The processor 130 may identify a first distance between the first electronic device and the robot cleaner 100 using the UWB communication module 120.

In this case, the first distance between the first electronic device and the robot cleaner 100 may be calculated based on time of flight (ToF).

For example, the processor 130 may transmit a signal (e.g., an ultra-wideband signal) using the UWB communication module 120. In this case, the first electronic device may receive a signal transmitted by the robot cleaner 100 using the UWB communication module. When a signal transmitted by the robot cleaner 100 is received, the first electronic device may transmit a signal (e.g., an ultra-wideband signal). Here, the signal transmitted by the first electronic device may include information about a delay time calculated based on the time when the first electronic device receives the signal from the robot cleaner 100 and the time when the first electronic device transmits the signal.

In this case, the processor 130 may, when the signal transmitted by the first electronic device is received through the UWB communication module 120, calculate distance between the robot cleaner 100 and the first electronic device.

For example, the processor 130 may calculate the distance between the robot cleaner 100 and the first electronic device based on the ToF. That is, the processor 130 may calculate the distance between the robot cleaner 100 and the first electronic device based on the time of transmitting the signal through the UWB communication module 120, the time of receiving the signal transmitted by the first electronic device through the UWB communication module 120, the delay time, and the speed of the light.

In addition, the processor 130 may identify the second distance between the second electronic device and the robot cleaner 100 using the wireless communication module 110.

For example, it is assumed that the wireless communication is Bluetooth communication. In this case, the processor 130 may receive a signal transmitted by the second electronic device through the Bluetooth communication module. In addition, the processor 130 may calculate the distance between the robot cleaner 100 and the second electronic device based on the intensity of the received signal. For this, in the memory of the robot cleaner 100, information about distance between the electronic devices by intensities of the received signal, and this distance may be a determined value through an experiment, etc.

In the meantime, the processor 130 may identify the third distance between the charging station located within the space and capable of the UWB communication and the robot cleaner 100 in operation S350.

In this case, the processor 130 may calculate the distance between the robot cleaner 100 and the charging station based on the ToF.

As such, the processor 130 may identify the first distance between the first electronic device and the robot cleaner 100, the second distance between the second electronic device and the robot cleaner 100, and the third distance between the charging station and the robot cleaner 100.

The processor 130 may identify the location of the robot cleaner 100 based on the first distance, the second distance, the third distance, the location of the first electronic device, the location of the second electronic device, and the location of the charging station in operation S360.

For this, the processor 130 may obtain the information about the location of the first electronic device and the location of the second electronic device from the server (not shown) through the Wi-Fi communication module.

For example, the mobile device may receive a map from a server (not shown) using an application installed in the mobile device, and display the map. Here, the map may be a map generated based on data obtained through various sensors while the robot cleaner 100 moves in a space.

In this case, the user may set the location of the electronic device on the map. For example, when a map is displayed through an application, a user may touch a point corresponding to a location where the electronic device is installed on a map. In this case, the mobile device may transmit information about the location of the point touched on the map to a server (not shown), and the server (not shown) may store information about the location of the electronic device on the map based on the information received from the mobile device.

Accordingly, the processor 130 may obtain the information about the location of the electronic device from the server (not shown) through the Wi-Fi communication module.

In addition, the processor 130 may obtain information about the location of the charging station.

For example, the robot cleaner 100 may be docked to the charging station before generating the map. In this case, when a user command for starting the cleaning operation is inputted, the processor 130 may perform cleaning while moving the robot cleaner 100. In addition, the processor 130 may generate a map of a space based on data obtained through various sensors while the robot cleaner 100 moves. Here, since the initial location of the robot cleaner 100 is the location of the charging station, the processor 130 may obtain information about the location of the charging station on the map.

This is merely an example, and the processor 130 may obtain the information about the location of the charging station from the server (not shown) through the Wi-Fi communication module. In this case, the location of the charging station may be set on the map according to the user command and stored in the server (not shown).

By the method above, the processor 130 may identify the location of the first electronic device, the location of the second electronic device, and the location of the charging station.

In the example above, it is described that the location of the first electronic device, the location of the second electronic device, and the location of the charging station are two-dimensional location on the map, but this is merely an example.

As another example, the processor 130 may obtain information about the height of the antenna included in the UWB communication module of the first electronic device, the height of the antenna included in the wireless communication module of the second electronic device and the height of the antenna included in the charging station and the UWB communication module. In this case, the processor 130 may obtain the corresponding information from the server (not shown), or obtain the information based on the user command input to the robot cleaner 100.

The processor 130 may identify the location of the robot cleaner 100 based on the distance between the robot cleaner 100 and the first electronic device, the distance between the robot cleaner 100 and the second electronic device, the distance between the robot cleaner 100 and the first electronic device, the location of the first electronic device, the location of the second electronic device, and the location of the charging station.

In this case, the processor 130 may identify the location of the robot cleaner 100 based on the distance among the devices using the trilateration.

For example, the processor 130 may generate a circle where a location of the first electronic device is a center of the circle and a distance between the robot cleaner 100 and the first electronic device is a radius, generate a circle where a location of the second electronic device is a center and a distance between the robot cleaner 100 and the second electronic device is a radius, and generate a circle where a location of the charging station is a center and a distance between the robot cleaner 100 and the charging station is a radius.

In addition, the processor 130 may determine a point at which an intersection point of these three circles is located on the map as the location of the robot cleaner 100.

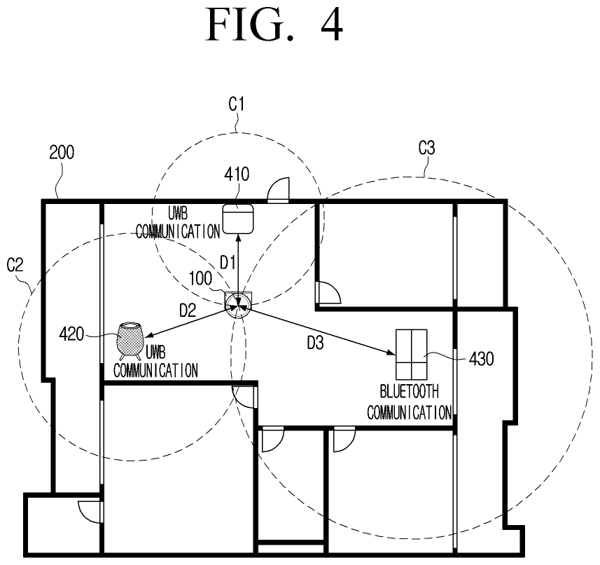

For example, as illustrated in FIG. 4, it is assumed that there are the charging station 410, the AI speaker 420 capable of UWB communication, and the refrigerator 430 capable of Bluetooth communication.

At this time, when the distance between the robot cleaner 100 and a charging station 410 is D1, the distance between the robot cleaner 100 and an AI speaker 420 is D2, and the distance between the robot cleaner 100 and a refrigerator 430 is D3, a circle C1 where the location of the charging station 410 is the center and the radius is D1, a circle C2 where the location of the AI speaker 420 is the center and the radius is D2, and a circle C3 where the location of the refrigerator 430 is the center and the radius is D3 may be generated.

In this case, the processor 130 may determine the point at which an intersection point of three circles C1, C2 C3 is located on the map 200 as the location of the robot cleaner 100.

FIG. 4 illustrates that the electronic device capable of the UWB communication is one (that is, AI speaker), the electronic device capable of wireless communication is one (that is, refrigerator), but this is for convenience of description. That is, the processor 13 may, when there are two electronic devices, identify the location of the robot cleaner 100 using the distance between each electronic device and the robot cleaner 100.

When there are at least two electronic devices capable of wireless communication, the processor 130 may identify the location of the robot cleaner 100 through the method as shown below.

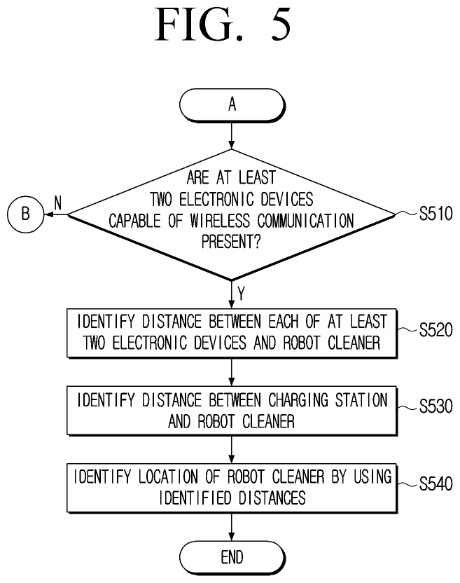

For example, as shown in FIG. 5, when it is identified that at least two electronic devices capable of wireless communication present in operation S510-Y, the processor 130 may identify a distance between each of the at least two electronic devices and the robot cleaner 100 using the wireless communication module 110 in operation S520. In this case, the processor 130 may identify a distance between each of the at least two electronic devices and the robot cleaner 100 based on the intensity of the signal received through the wireless communication module.

In addition, the processor 130 may identify the third distance between the robot cleaner 100 and the charging station in operation S530.

Then, the processor 130 may identify the location of the robot cleaner 100 based on the distance between each of at least two electronic devices and the robot cleaner 100, the third distance, location of each of at least two electronic devices and the location of the charging station in operation S540.

In this case, the processor 130 may identify the location of the robot cleaner 100 based on the distances among the devices using the trilateration.

For example, the processor 130 may generate a circle where locations of each of at least two electronic devices is the center and the distance between the robot cleaner 100 and the at least two electronic devices is the radius, and may generate a circle where the location of the charging station is the center and the distance between the charging station and the robot cleaner 100 is the radius.

In addition, the processor 130 may determine the point at which the intersection of at least three circles is located on the map as the location of the robot cleaner 100.

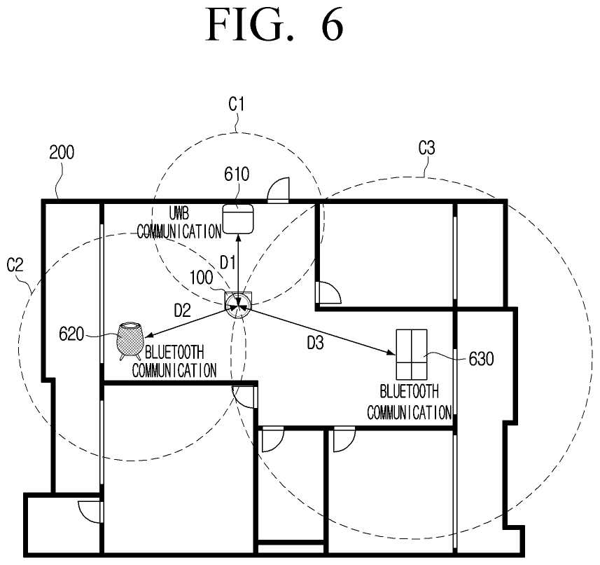

For example, as illustrated in FIG. 6, it is assumed that there are the charging station 610, the AI speaker 620 capable of UWB communication, and the refrigerator 630 capable of Bluetooth communication.

When the distance between the robot cleaner 100 and a charging station 610 is D1, the distance between the robot cleaner 100 and an AI speaker 620 is D2, and the distance between the robot cleaner 100 and a refrigerator 630 is D3, a circle C1 where the location of the charging station 610 is the center and the radius is D1, a circle C2 where the location of the AI speaker 620 is the center and the radius is D2, and a circle C3 where the location of the refrigerator 630 is the center and radius is D3 may be generated.

In this case, the processor 130 may determine the point at which an intersection point of three circles C1, C2 C3 is located on the map 200 as the location of the robot cleaner 100.

As described above, referring to FIGS. 3, 4, 5 and 6, the robot cleaner 100 according to an embodiment of the disclosure may identify the location of the robot cleaner 100 using peripheral devices using different communication schemes (e.g., UWB communication and Bluetooth communication). Also, since peripheral devices are installed in a fixed location instead of a mobile device of which location is changed, the robot cleaner 100 may more accurately identify its location using these devices.

The processor 130 may identify the location of the robot cleaner 100 through the method as shown below when an electronic device capable of wireless communication is not present and at least two electronic devices capable of the UWB communication are present.

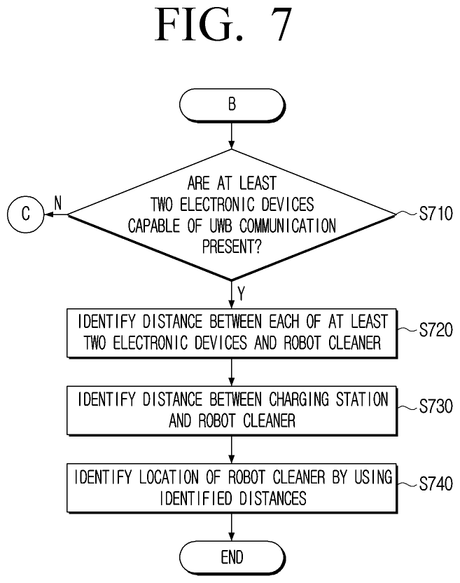

For example, as shown in FIG. 7, when it is identified that an electronic device capable of wireless communication is not present and at least two electronic devices capable of UWB communication are present in operation S710-Y, the processor 130 may identify a distance between each of the at least two electronic devices and the robot cleaner 100 using the UWB communication module 120 in operation S720. In this case, the processor 130 may identify a distance between each of the at least two electronic devices and the robot cleaner 100 based on the ToF.

In addition, the processor 130 may identify the third distance between the robot cleaner 100 and the charging station in operation S730.

The processor 130 may identify the location of the robot cleaner 100 based on the distance between each of at least two electronic devices and the robot cleaner 100, the third distance, location of each of at least two electronic devices, and the location of the charging station in operation S740.

In this case, the processor 130 may identify the location of the robot cleaner 100 based on the distance among devices using the trilateration.

For example, the processor 130 may generate a circle where a location of each of at least two electronic devices is the center and the distance between the robot cleaner 100 and the at least two electronic devices is the radius, and may generate a circle where the location of the charging station is the center and the distance between the charging station and the robot cleaner 100 is the radius.

In addition, the processor 130 may determine the point at which the intersection of at least three circles is located on the map as the location of the robot cleaner 100.

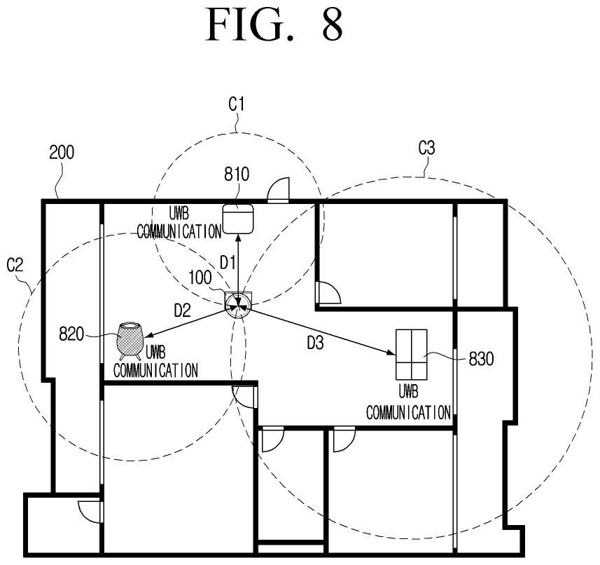

For example, as illustrated in FIG. 8, it is assumed that there are a charging station 810, an AI speaker 820 capable of UWB communication, and a refrigerator 830 capable of Bluetooth communication.

When the distance between the robot cleaner 100 and the charging station 810 is D1, the distance between the robot cleaner 100 and the AI speaker 820 is D2, and the distance between the robot cleaner 100 and the refrigerator 830 is D3, a circle C1 where the location of the charging station 810 is the center and the radius is D1, a circle C2 where the location of the AI speaker 820 is the center and the radius is D2, and a circle C3 where the location of the refrigerator 830 is the center and the radius is D3 may be generated.

In this case, the processor 130 may determine the point at which an intersection point of three circles C1, C2 C3 is located on the map 200 as the location of the robot cleaner 100.

As described above, referring to FIGS. 7 and 8, the robot cleaner 100 according to an embodiment of the disclosure may identify the location of the robot cleaner 100 using peripheral devices using a UWB communication method. Also, since peripheral devices are devices installed in a fixed location rather than a mobile device, the robot cleaner 100 may more accurately identify its location.

In the above embodiments, it is described that when the location of the charging station, the location of the electronic device capable of UWB communication, and the location of the electronic device capable of wireless communication are preset on the map, the location of the robot cleaner 100 is determined on the map based thereon.

If the location of devices has not be preset, the processor 130 may determine the location of the robot cleaner 100 with respect to the devices, that is, the relative location of the robot cleaner 100.

For example, it is assumed that an AI speaker, a refrigerator, and a charging station are present. The AI speaker, the refrigerator, and the charging station may all be devices capable of UWB communication. In this case, the devices may perform UWB communication with each other to obtain information about a distance between devices, and transmit information about a distance to the robot cleaner 100 using a UWB communication module.

In this case, the processor 130 may set the location of the charging station as a reference location. In addition, the processor 130 may determine the location of the AI speaker and the refrigerator based on the charging station using information about the distance between the devices.

For example, it is assumed that the location of the charging station is set to (0,0,0). In this case, when the distance between the charging station and the AI speaker is D, the processor 130 may determine the location of the AI speaker to (D,0,0).

In addition, the processor 130 may determine the location of the refrigerator to (a,b,0). For example, the processor 130 may generate a circle where (0,0,0) (=the location of the charging station) is the center and the distance between the refrigerator and the charging station is the radius, and may generate a circle where (D,0,0) (=location of the AI speaker) is the center and the distance between the refrigerator and the AI speaker is the radius. In this case, the two circles have two intersection points, and the processor 130 may determine an intersection point, between two intersection points, where x and y coordinates have (+) value as the location of the refrigerator.

The processor 130 may determine a relative location of the robot cleaner 100 with respect to the devices using the determined locations, the distance between the robot cleaner 100 and the refrigerator, the distance between the robot cleaner 100 and the AI speaker, and the distance between the robot cleaner 100 and the charging station.

In the above embodiments, it has been described that the location of the robot cleaner 100 is determined using three electronic devices including the charging station, but this is merely an example.

The processor 130 may determine the location of the robot cleaner 100 using two electronic devices including the charging station. In this case, the location of the robot cleaner 100 may correspond to a relative location with respect to the electronic device. In addition, the processor 130 may determine the location of the electronic device using the location of the robot cleaner 100.

For example, as illustrated above, the processor 130 may set the location of the charging station as (0,0,0) and when the distance between the charging station and the AI speaker is D, the processor 130 may determine the location of the AI speaker as (D,0,0).

In addition, the processor 130 may determine the location of the robot cleaner 100 as (a,b,0). For example, the processor 130 may generate a circle where (0,0,0) (=location of the charging station) is the center and the distance between the robot cleaner 100 and the charging station is the radius, and may generate a circle where (D,0,0) (=location of the AI speaker) is the center and having the distance between the robot cleaner 100 and the AI speaker is the radius. In this case, two circles have two intersections and at this time, the processor 130 may determine the intersection, between two intersections, in which x, y coordinates have (+) value as the temporary location of the robot cleaner 100.

The processor 130 may generate a map based on the data obtained through various sensors of the robot cleaner 100 while the robot cleaner 100 is moving, and may identify the location of the robot cleaner 100 on the map.

The processor 130 may identify whether the temporary location is a correct location using the map and the location of the robot cleaner 100 on the map.

For example, the processor 130 may, when the temporary location of the robot cleaner 100 is a location that may not be present on the map, identify that the temporary location of the robot cleaner 100 is not a correct location.

In this example, the processor 130 may determine that the other of the two intersections is the relative location of the robot cleaner 100 with respect to the location of the charging station and the location of the AI speaker. In addition, the processor 130 may determine the location of the charging station and the location of the AI speaker using the location of the robot cleaner 100 and the relative location of the robot cleaner 100 on the map.

If it is identified that the temporary location of the robot cleaner 100 is the correct location, the processor 130 may determine that the corresponding location is the relative location of the robot cleaner 100 with respect to the location of the charging station and the location of the AI speaker. In addition, the processor 130 may determine the location of the charging station and the location of the AI speaker using the location of the robot cleaner 100 and the relative location of the robot cleaner 100 on the map.

According to an embodiment of the disclosure, the processor 130 may identify the location of the robot cleaner 100 through the following method when at least two electronic devices capable of UWB communication are not present, but an electronic device capable of angle of arrival (AOA) measurement is present using UWB communication.

For this, the processor 130 may identify whether an electronic device capable of the AOA measurement is present.

The AOA may refer to technology for determining the direction (that is, the angle at which the electronic device that has transmitted the signal with reference to the electronic device that has received the signal) of the electronic device that has transmitted the signal using the time and the angle at which the signal is received to each of the at least two antennas.

In addition, the electronic device capable of the AOA measurement may include at least two antennas and may refer, for example, to an electronic device that may measure distance from an external electronic device through the ToF, or an electronic device capable of measuring even direction of the external electronic device through the AOA.

In this case, the processor 130 may receive information about the number of antennas from a server (not shown) through the Wi-Fi communication module to identify whether an electronic device capable of the AOA measurement is present. However, this is merely an example, and the processor 130 may communicate with the electronic device using various communication methods such as UWB communication, wireless communication, IR communication, etc. to obtain information about the number of antennas from the electronic device, and may identify whether the electronic device is an electronic device capable of the AOA measurement using the obtained information.

In this case, the processor 130 may identify an electronic device capable of the AOA measurement among IoT devices and mobile devices present in a space in which the robot cleaner 100 is located, without distinguishing whether the electronic device is an electronic device installed at a fixed location or a mobile device.

The processor 130 may communicate with the third electronic device using the UWB communication module 120 to obtain information about the distance between the third electronic device and the robot cleaner 100 and the direction of the robot cleaner 100 in operation S920 when it is identified that the electronic device capable of wireless communication is not present and the third electronic device capable of the AOA measurement is present using UWB communication in operation S910-Y.

For example, the third electronic device may determine the direction of the robot cleaner 100 based on the third electronic device by performing UWB communication with the robot cleaner 100, and may also determine the distance between the third electronic device and the robot cleaner 100. In this case, the direction of the robot cleaner 100 may be measured by AOA, and the distance between the third electronic device and the robot cleaner 100 may be measured by the ToF.

In addition, the processor 130 may obtain information about the distance between the third electronic device and the charging station and the direction of the charging station by communicating with the third electronic device using the UWB communication module 120 in operation S930.

For example, the third electronic device performs UWB communication with the charging station to determine the direction of the charging station based on the third electronic device, and may also determine the distance between the third electronic device and the charging station. In this case, the direction of the charging station may be measured by the AOA, and the distance between the third electronic device and the charging station may be measured by the ToF.

The processor 130 may identify the location of the robot cleaner 100 based on the distance between the third electronic device and the robot cleaner 100, the distance between the third electronic device and the charging station, and the direction of the robot cleaner 100 and the direction of the charging station with reference to the third electronic device in operation S940.

It is assumed that the location of the devices is preset on the map. In this case, the processor 130 may identify the location of the robot cleaner 100 using the location of the third electronic device, the direction of the robot cleaner 100 with reference to the third electronic device, and the distance between the third electronic device and the robot cleaner 100.

If the location of devices has not be preset, or the third electronic device is a mobile device, the processor 130 may identify the location of the robot cleaner 100 with respect to the devices, that is, the relative location of the robot cleaner 100.

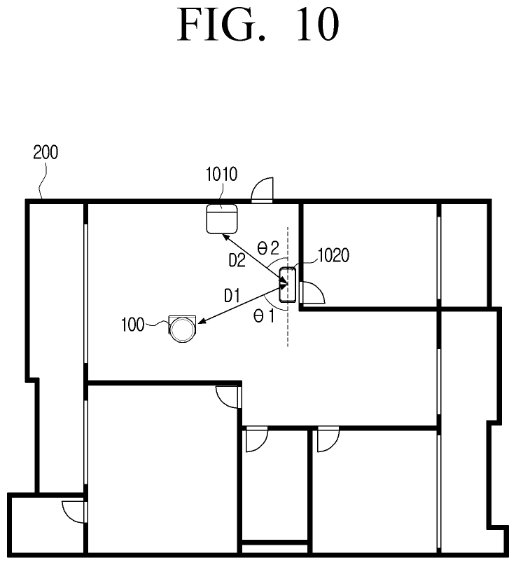

For example, as illustrated in FIG. 10, it is assumed that the third electronic device is a mobile device.

In this case, the processor 130 may set the location of a charging station 1010 as a reference location. The processor 130 may determine the location of the mobile device 1020 based on the charging station 1010 based on the distance between the mobile device 1020 and the charging station 1010 (e.g., D2 of FIG. 10) and the direction of the charging station 1010 (e.g., 02 of FIG. 10) based on the mobile device 1020. That is, the processor 130 may determine the relative location of the mobile device 1020 with respect to the charging station 1010.

In addition, the processor 130 may determine the location of the robot cleaner 100 based on the charging station 1010 and the mobile device 1020 based on the relative location of the mobile device 1020, the distance between the mobile device 1020 and the robot cleaner 100 (for example, D1 of FIG. 10), and the direction of the robot cleaner 100 (for example, 01 in FIG. 10) based on the mobile device 1020. That is, the processor 130 may determine the relative location of the robot cleaner 100 with respect to the charging station 1010 and the mobile device 1020.

In the example above, it is assumed that the third electronic device includes at least three antennas for the UWB communication.

In this case, the third electronic device may identify the distance between each of at least three antennas of the third electronic device and the robot cleaner 100 using the UWB communication module. In this case, the distance may be calculated based on the ToF.

In addition, the third electronic device may identify the location of the robot cleaner 100 with reference to the third electronic device based on the identified distances.

For example, it is assumed that the UWB communication module of the third electronic device includes three antennas (hereinafter, first to third antennas).

In this case, the third electronic device may generate a circle where the location of the first antenna is the center and the distance between the first antenna and the robot cleaner 100 is the radius, generate a circle where the location of the second antenna is the center and the distance between the second antenna and the robot cleaner 100 is the radius, and generate a circle where the location of the third antenna is the center and the distance between the third antenna and the robot cleaner 100 is the radius.

In addition, the third device may determine the point at which the intersection of these three circles is located as the location of the robot cleaner 100 with reference to the third electronic device. In this case, the third electronic device may transmit the information about the relative location of the robot cleaner 100 to the robot cleaner 100 using the UWB communication module.

Accordingly, the processor 130 may determine the location of the robot cleaner 100 with reference to the charging station based on the relative location of the third electronic device with respect to the charging station and the relative location of the robot cleaner 100 with respect to the third electronic device.

As described above, according to various embodiments of the disclosure, the processor 130 may identify the location of the robot cleaner 100.

In this case, the processor 130 may, when the location of the robot cleaner 100 is identified, perform various operations based on the identified location.

For example, the processor 130 may control the robot cleaner 100 to perform a cleaning operation for a remaining area on the map based on the identified location, or may control the robot cleaner 100 so that the robot cleaner 100 moves to the charging station based on the identified location.

According to various embodiments as described above, even if a user arbitrarily changes the location of the robot cleaner 100, the robot cleaner 100 may recognize its location and may perform various operations and thus, user's convenience may be improved.

In the various example embodiments described above, when the location of the robot cleaner 100 is changed by a user, the robot cleaner 100 identifies the location of the robot cleaner 100 using various communication methods, but this is merely an example. For example, the robot cleaner 100 may identify the location through the above-described method even if the location of the robot cleaner 100 is not changed by the user.

When the cleaning operation is completed, the robot cleaner 100 may return to the charging station and perform docking on the charging station. When the location of the charging station is changed by the user while the robot cleaner 100 performs the cleaning operation, the robot cleaner 100 may not return to the charging station after the cleaning operation is completed.

Accordingly, according to an embodiment of the disclosure, the robot cleaner 100 may identify the location of the charging station when the location of the charging station is changed by the user, which will be described in more detail below.

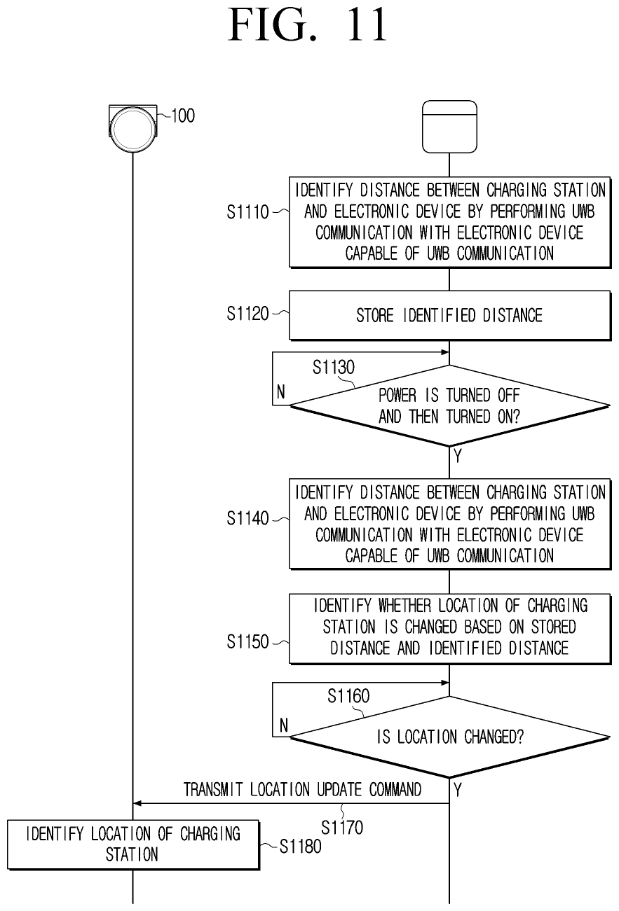

For example, referring to FIG. 11, the charging station may determine that a location of the charging station has been changed.

For example, the charging station may perform communication with electronic devices capable of UWB communication using a UWB communication module to identify a distance between the charging station and the electronic devices in operation S1110. In addition, the charging station may store information about the identified distance in a memory of the charging station in operation S1120.

When the power is turned off and then turned on again in operation S1130-Y, the charging station may identify the distance between the charging station and the electronic devices by performing communication again with electronic devices capable of UWB communication using the UWB communication module in operation S1140.

In addition, the charging station may identify whether difference between the stored distance and the identified distance is less than a threshold value, and accordingly, may identify whether the location of the charging station has been changed in operation S1150.

For example, when the difference between the stored distance and the identified distance is less than or equal to a threshold value, the charging station may determine that the location of the charging station is not changed, and when the difference between the stored distance and the identified distance is greater than a threshold value, may determine that the location of the charging station is not changed.

For example, when the user changes the location of the charging station to another place in a house, a plug of the charging station may be separated from an outlet and connected to an outlet provided in another place. In this process, the power of the charging station may be turned off and then turned on again. In addition, when the location of the charging station is changed, the distance between the peripheral devices and the charging station is also changed, and thus the charging station may determine whether the location of the charging station has changed by comparing a difference between the measured distance before the power is turned off and the measured distance after the power is turned on again with a threshold value.

If it is identified that the location of the charging station is changed in operation S1160-Y, the charging station may transmit a location update command to the robot cleaner 100 through a server (not shown) using a Wi-Fi communication module in operation S1170. However, this is merely an example, and the charging station may transmit a location update command to the robot cleaner 100 using various communication methods such as UWB communication, IR communication, and the like.

Accordingly, when receiving the location update command, the processor 130 may identify the location of the charging station on the map in operation S1180. In addition, the processor 130 may update the location of the charging station on the map.

For example, the processor 130 may, based on identifying that the location of the charging station is changed, identify distances between the charging station and the robot cleaner 100 using the UWB communication module 120 while the robot cleaner 100 is located at three different locations. In this example, the processor 130 may determine the distance between the robot cleaner 100 and the charging station based on the ToF.

The three different locations may be determined based on accuracy of the distance between the robot cleaner and the charging station identified based on the UWB communication.

The charging station may be determined whether the robot cleaner 100 is located on a line of sight (LOS) with reference to the charging station.

For example, if there is no obstacle between the robot cleaner 100 and the charging station, the robot cleaner 100 may be seen as being located on the LOS from the charging station. In this case, the signal transmission/reception between the robot cleaner 100 and the charging station is not disturbed by an obstacle, and accordingly, the accuracy of the distance between the robot cleaner 100 and the charging station calculated by the processor 130 may be high.

Accordingly, the processor 130 may measure the distances between the robot cleaner 100 and the charging station multiple times at any locations while the robot cleaner 100 moves, and may identify whether the location of the robot cleaner 100 is located on the LOS based on the measured distances.

For example, the processor 130 may calculate an average value of the distances measured by multiple times at arbitrary locations and may compare the measured distance values with the average value.

If the difference between the measured distances and the average value is less than a threshold value, it may be determined that the location of the robot cleaner 100 is present on the LOS, and if the difference between the measured distances and the average value is greater than or equal to the threshold value, it may be determined that the location of the robot cleaner 100 is not present on the LOS.

For example, when an obstacle is present between the robot cleaner 100 and the charging station, due to obstruction by an obstacle, even if the robot cleaner 100 measures distance at the same location, an error among the measured distance values may be large.

Accordingly, by comparing the distance between the measured distances and an average value, the processor 130 may determine whether the location of the robot cleaner 100 is on the LOS, and if the location of the robot cleaner 100 is present on the LOS, may determine that the distance between the robot cleaner 100 measured at the corresponding location and the charging station has a high accuracy.

Through this process, the processor 130 may determine the distances between the robot cleaner 100 and the charging station measured in at least three locations on the LOS by the robot cleaner 100.

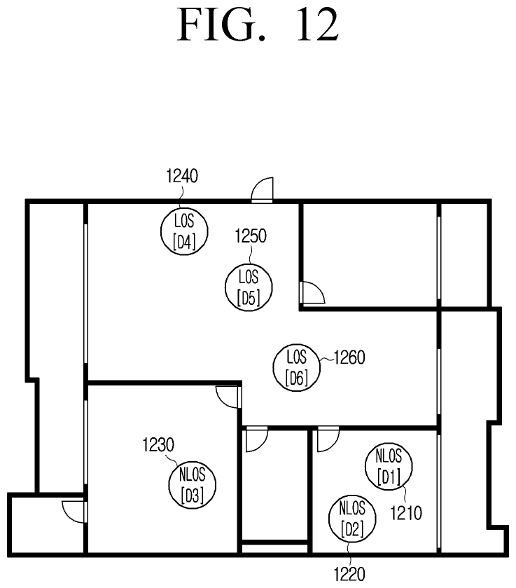

For example, as illustrated in FIG. 12, it is assumed that the processor 130 measures the distance between the robot cleaner 100 and the charging station while each of the robot cleaner 100 is located at each of fix points 1210 to 1260.

In this case, the processor 130 may determine that, as to three points 1210, 1220, 1230 among six points 1210 to 1260, the location of the robot cleaner 100 is non-LOS (NLOS), and as to three points 1240, 1250, 1260, the location of the robot cleaner 100 is LOS.

In this case, the processor 130 may identify distances D4, D5, D6 between the robot cleaner 100 and the charging station measured by the robot cleaner 100 at three locations 1240, 1250, 1260 present in the LOS.

In addition, the processor 130 may identify the location of the charging station based on the identified distance.

At this time, the three different locations are called first to third locations.

In this case, the processor 130 may generate a circle where the first location (e.g., 1240 of FIG. 12) is the center and the distance (e.g., D4 of FIG. 12) between the robot cleaner 100 and the charging station is the radius, generate a circle where the second location (e.g., 1250 of FIG. 12) is the center and the distance (e.g., D5 of FIG. 12) between the robot cleaner 100 and the charging station is the radius, and generate a circle where the third location (e.g., 1260 of FIG. 12) is the center and the distance (e.g., D6 of FIG. 12) between the robot cleaner 100 and the charging station is the radius.

In addition, the processor 130 may determine the point at which an intersection of three circles is located on the map as the location of the charging station. The processor 130 may update the location of the charging station on the map based on the determined location.

In the above-described example, it has been described that the location of the charging station is identified when the robot cleaner 100 receives the location update command from the charging station, but this is an example. For example, even though a location update command is not received, if an operation (that is, homing operation) to return to the charging station fails, the processor 130 may determine the location of the charging station and update the location of the charging station on the map based on the determined location.

According to the various embodiments of the disclosure, even if a user arbitrarily changes a location of the charging station, the robot cleaner 100 may recognize a location of the charging station and perform a returning operation to the charging station and thus, a user convenience may be improved.

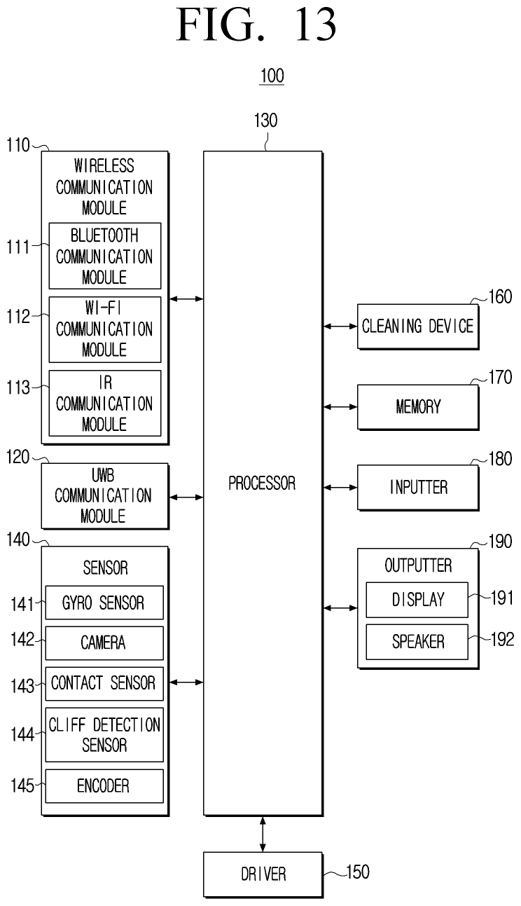

FIG. 13 is a block diagram illustrating an example configuration of a robot cleaner according to an embodiment of the disclosure.

Referring to FIG. 13, the robot cleaner 100 may include the wireless communication module (e.g., including communication circuitry) 110, the UWB communication module (e.g., including UWB communication circuitry) 120, the processor (e.g., including processing circuitry) 130, a sensor 140, a driver 150, a memory 160, an inputter (e.g., including input circuitry) 170, and an outputter (e.g., including output circuitry 180. However, in practicing the disclosure, a new configuration may be added or some components may be omitted in addition to such a configuration. In describing FIG. 13, descriptions overlapping with FIGS. 1 to 12 may not be repeated.

The wireless communication module 110 may include a Bluetooth communication module 111, a Wi-Fi communication module 112, and an IR communication module 113, each including various circuitry.

In addition, the sensor 140 may include the gyro sensor 141, the camera 142, the contact sensor 143, the cliff detection sensor 144, and the encoder 145.

The gyro sensor 141 may generate data by sensing the angular velocity of the robot cleaner 100 and provide the data to the processor 130. The camera may capture the surroundings of the robot cleaner 100, obtain at least one image about the surroundings of the robot cleaner 100, and provide the obtained image to the processor 130.

In this case, the processor 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. For example, the processor 130 may generate a map for a space in which the robot cleaner 100 is located based on data obtained through the gyro sensor 141 and the camera 142, and may also identify the location of the robot cleaner 100 on the map. In this case, the processor 130 may use SLAM.

According to an embodiment, the sensor 140 may further include a 3D sensor for sensing the distance between the robot cleaner 100 and a peripheral object. In addition, the sensor 140 may further include a light detection and ranging (LiDAR) sensor for detecting a distance between the robot cleaner 100 and the peripheral object using a laser.

The contact sensor 143 may detect a contact between a wheel and a ground of the robot cleaner 100. The cliff detection sensor 144 may detect a cliff under the robot cleaner 100. In addition, the encoder 145 may detect the number of rotations of wheels installed on the left and right sides of the main body of the robot cleaner 100, respectively.

The driver 150 is configured to move the robot cleaner 100. For example, the driver 150 may include wheels installed on the left and right sides of the main body of the robot cleaner 100, respectively, and a motor for driving the wheels. Accordingly, the driver 150 may perform various driving operations such as movement, stop, speed control, direction change, and angular velocity change of the robot cleaner 100.

A cleaning device 160 may suck foreign substances. For this, the cleaning device 160 may include a brush, a motor, a dust box, and the like. Specifically, the processor 130 may rotate a brush for collecting foreign substances, generate a suction force through a motor or the like, and suck foreign substances from the bottom surface on which the robot cleaner 100 travels. As described above, the processor 130 may control the cleaning device 160 to perform a cleaning operation while the robot cleaner 100 moves the cleaning area. At this time, the sucked foreign substances may be accommodated in the dust container. In addition, according to an embodiment, the cleaning device 160 may further include a mop.

At least one instruction related to the robot cleaner 100 may be stored in the memory 170. An operating system (O/S) for driving the robot cleaner 100 may be stored in the memory 170. In addition, various software programs or data for operating the robot cleaner 100 may be stored in the memory 170 according to various embodiments of the disclosure. In this case, the processor 130 may control the operation of the robot cleaner 100 by executing various software modules stored in the memory 170.

The memory 170 may include a volatile memory, a flash memory, or the like. In the disclosure, the term memory 170 may be used to denote the memory 170, read-only memory (ROM) (not shown) in the processor 130, RAM (not shown), or a memory card (for example, a micro secure digital (SD) card, and a memory stick) mounted to the robot 100.

In addition, various data used for generating a map and data for the generated map may be stored in the memory 170.

The inputter 180 may include a circuit and receive a user command for setting or selecting various functions supported by the robot cleaner 100. For this, the inputter 180 may include a plurality of buttons, and may be implemented as a touch screen capable of simultaneously performing functions of the display 191.

In this case, the processor 130 may control the operation of the robot cleaner 100 based on a user command input through the inputter 180. For example, the processor 130 may control the robot cleaner 100 based on an on/off command of the robot cleaner 100 input through the inputter 180 of the robot cleaner 100, an on/off command of the function of the robot cleaner 100 (for example, a cleaning operation, etc.).

The outputter 190 may include the display 191 and the speaker 192.

The display 191 may display various information. For this, the display 181 may be implemented with a liquid crystal display (LCD), or the like, and may be implemented with a touch screen capable of simultaneously performing a function of the inputter 180.

For example, the processor 130 my display, on the display 101, information (e.g., cleaning progression time, current cleaning mode, battery information, charging state, whether a dust box is full of dust, information about an error state, etc.) related to the operation of the robot cleaner 100.

The speaker 192 may output audio. For example, the processor 130 may output various notification sounds or voice guidance messages related to the operation of the robot cleaner 100 through the speaker 192.

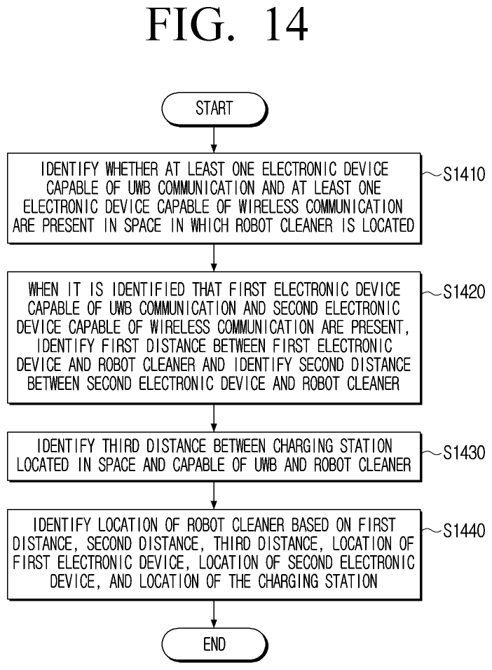

FIG. 14 is a flowchart illustrating an example method for identifying a location of a robot cleaner according to various embodiments.

It is identified whether at least one electronic device capable of UWB communication and at least one electronic device capable of wireless communication are present in a space in which the robot cleaner is located in operation S1410.

When it is identified that the first electronic device capable of UWB communication and the second electronic device capable of wireless communication are present, the first distance between the first electronic device and the robot cleaner is identified using the UWB communication module, and the second distance between the second electronic device and the robot cleaner is identified using the wireless communication module in operation S1420. Here, the wireless communication may be a communication scheme different from the UWB communication. For example, the wireless communication may be Bluetooth communication.

In addition, the third distance between the robot cleaner and the charging station located in the space and capable of UWB is identified in operation S1430.

The location of the robot cleaner is identified based on the first distance, the second distance, the third distance, the location of the first electronic device, the location of the second electronic device, and the location of the charging station in operation S1440.

In operation S1410, based on the first electronic device being an electronic device capable of the UWB communication and installed at a fixed location in the place, it is identified that the first electronic device is an electronic device capable of the UWB communication, and based on the second electronic device being an electronic device capable of the wireless communication and installed at a fixed location in the place, it is identified that the second electronic device is an electronic device capable of the wireless communication.

Based on identifying that at least two electronic devices capable of the wireless communication are present, the distance between each of the at least two electronic devices and the robot cleaner may be identified using the wireless communication module, and the location of the robot cleaner may be identified based on the distance between each of the at least two electronic devices and the robot cleaner, the third distance, locations of each of the at least two electronic devices, and the location of the charging station.

Based on identifying that the electronic device capable of the wireless communication is not present and at least two electronic devices capable of the UWB communication are present, the distance between the at least two electronic devices and the robot cleaner may be identified using the UWB communication module, and the location of the robot cleaner may be identified based on distance between each of the at least two electronic devices and the robot cleaner, the third distance, locations of each of the at least two electronic devices, and the location of the charging station.

In addition, based on identifying that the electronic device capable of the wireless communication is not present, and a third electronic device capable of angle of arrival (AOA) measurement using the UWB communication is present, the location of the robot cleaner may be identified based on distance between the third electronic device and the robot cleaner, the direction of the robot cleaner and the direction of the charging station with reference to the third electronic device.

In addition, in operation S1410, based on identifying that the location of the robot cleaner is moved by a user based on data obtained by the sensor, it may be identified whether the electronic device capable of the UWB communication and the electronic device capable of wireless communication are present.

In addition, based on identifying that the location of the charging station is changed, it may be identified distances between the charging station and the robot cleaner using the UWB communication module while the robot cleaner is located at three different locations, and the location of the charging station may be identified based on the identified distance. The three different locations may be determined based on accuracy of the distance between the robot cleaner and the charging station identified based on the UWB communication.

A specific method for identifying the location of the robot cleaner by communicating with peripheral devices and identifying the location of the charging station has been described above.

The various example embodiments as described above may be implemented with software including instructions stored in the machine-readable storage media readable by a machine (e.g., a computer). A machine may refer, for example, to a device which may call instructions from the storage medium and operate according to the called instructions, and may include an electronic device of various embodiments. When the instructions are executed by a processor, the processor may perform a function corresponding to the instructions directly or using other components under the control of the processor. The instructions may include a code generated by a compiler or a code executable by an interpreter. A machine-readable storage medium may be provided in the form of a non-transitory storage medium. Herein, the “non-transitory” storage medium does not include a signal (e.g., electromagnetic wave) but is tangible, and does not distinguish the case in which a data is semi-permanently stored in a storage medium from the case in which a data is temporarily stored in a storage medium. For example, “non-transitory storage medium” may refer to a buffer temporarily storing data.

A method according to one or more embodiments may be provided included a computer program product. The computer program product may be exchanged between a seller and a purchaser as a commodity. The computer program product may be distributed in the form of a machine-readable storage medium (e.g., a compact disc read only memory (CD-ROM)), or distributed (e.g., download or upload) online directly among at least two user devices (e.g., smartphones) through an application store (e.g., PlayStore™). In the case of online distribution, at least a portion of the computer program product (e.g., downloadable app) may be at least stored temporarily in a storage medium such as a server of a manufacturer, a server of an application store, or a memory of a relay server, or temporarily generated.

While the disclosure has been illustrated and described with reference to various example embodiments, it will be understood that the various embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A robot cleaner comprising:
a wireless communication module comprising wireless communication circuitry;
a ultra wideband (UWB) communication module comprising UWB circuitry; and
at least one processor, comprising processing circuitry, individually and/or collectively configured to:
identify whether at least one electronic device capable of UWB communication and at least one electronic device capable of wireless communication are present in a space where the robot cleaner is located,
based on presence of a first electronic device capable of UWB communication and a second electronic device capable of wireless communication being identified, identify a first distance between the first electronic device and the robot cleaner using the UWB communication module, identify a second distance between the second electronic device and the robot cleaner using the wireless communication module,
identify a third distance between a charging station, located in the space and capable of UWB communication, and the robot cleaner using the UWB communication module, and
identify the location of the robot cleaner based on the first distance, the second distance, the third distance, the location of the first electronic device, the location of the second electronic device, and the location of the charging station,
wherein the wireless communication includes a communication scheme different from the UWB communication.

2. The robot cleaner of claim 1, wherein the wireless communication includes Bluetooth communication.

3. The robot cleaner of claim 1, wherein at least one processor, individually and/or collectively, is configured to:
based on the first electronic device being an electronic device capable of UWB communication and installed at a fixed location in the place, identify that the first electronic device is an electronic device capable of UWB communication, and
based on the second electronic device being an electronic device capable of wireless communication and installed at a fixed location in the place, identify that the second electronic device is an electronic device capable of wireless communication.

4. The robot cleaner of claim 1, wherein at least one processor, individually and/or collectively, is configured to:
based on identifying that at least two electronic devices capable of wireless communication are present, identify a distance between each of the at least two electronic devices and the robot cleaner using the wireless communication module, and
identify the location of the robot cleaner based on the distance between each of the at least two electronic devices and the robot cleaner, the third distance, locations of each of the at least two electronic devices, and the location of the charging station.

5. The robot cleaner of claim 1, wherein at least one processor, individually and/or collectively, is configured to:
based on identifying that the electronic device capable of the wireless communication is not present and at least two electronic devices capable of UWB communication are present, identify distance between the at least two electronic devices and the robot cleaner using the UWB communication module, and
identify the location of the robot cleaner based on the distance between each of the at least two electronic devices and the robot cleaner, the third distance, locations of each of the at least two electronic devices, and the location of the charging station.

6. The robot cleaner of claim 1, wherein at least one processor, individually and/or collectively, is configured to, based on identifying that the electronic device capable of wireless communication is not present, and a third electronic device capable of angle of arrival (AOA) measurement using the UWB communication is present, identify the location of the robot cleaner based on distance between the third electronic device and the robot cleaner, the direction of the robot cleaner and the direction of the charging station with reference to the third electronic device.

7. The robot cleaner of claim 1, further comprising:
a sensor,
wherein at least one processor, individually and/or collectively, is configured to, based on identifying that the location of the robot cleaner is moved based on data obtained by the sensor, identify whether the electronic device capable of the UWB communication and the electronic device capable of wireless communication are present.

8. The robot cleaner of claim 1, wherein at least one processor, individually and/or collectively, is configured to:
based on identifying that the location of the charging station is changed, identify distances between the charging station and the robot cleaner using the UWB communication module while the robot cleaner is located at three different locations, and identify the location of the charging station based on the identified distances, and
wherein the three different locations are determined based on accuracy of the distance between the robot cleaner and the charging station identified based on the UWB communication.

9. A location identification method of a robot cleaner comprising a ultra wideband (UWB) communication module and a wireless communication module, the method comprising:
identifying whether at least one electronic device capable of UWB communication and at least one electronic device capable of wireless communication are present in a space where the robot cleaner is located;
based on the presence of a first electronic device capable of UWB communication and a second electronic device capable of wireless communication being identified, identifying a first distance between the first electronic device and the robot cleaner using the UWB communication module, identifying a second distance between the second electronic device and the robot cleaner using the wireless communication module;
identifying a third distance between a charging station, located in the space and capable of UWB communication, and the robot cleaner using the UWB communication module; and
identifying the location of the robot cleaner based on the first distance, the second distance, the third distance, the location of the first electronic device, the location of the second electronic device, and the location of the charging station,
wherein the wireless communication includes a communication scheme different from the UWB communication.

10. The method of claim 9, wherein the wireless communication includes a Bluetooth communication.

11. The method of claim 9, wherein the identifying whether at least one electronic device capable of UWB communication and at least one electronic device capable of wireless communication are present comprises:
based on the first electronic device being an electronic device capable of UWB communication and installed at a fixed location in the place, identifying that the first electronic device is an electronic device capable of the UWB communication, and
based on the second electronic device being an electronic device capable of wireless communication and installed at a fixed location in the place, identifying that the second electronic device is an electronic device capable of the wireless communication.

12. The method of claim 9, further comprising:
based on identifying that at least two electronic devices capable of wireless communication are present, identifying a distance between each of the at least two electronic devices and the robot cleaner using the wireless communication module; and
identifying the location of the robot cleaner based on the distance between each of the at least two electronic devices and the robot cleaner, the third distance, locations of each of the at least two electronic devices, and the location of the charging station.

13. The method of claim 9, further comprising:
based on identifying that the electronic device capable of the wireless communication is not present and at least two electronic devices capable of UWB communication are present, identifying distance between the at least two electronic devices and the robot cleaner using the UWB communication module; and
identifying the location of the robot cleaner based on distance between each of the at least two electronic devices and the robot cleaner, the third distance, locations of each of the at least two electronic devices, and the location of the charging station.

14. The method of claim 9, further comprising, based on identifying that the electronic device capable of wireless communication is not present, and a third electronic device capable of angle of arrival (AOA) measurement using the UWB communication is present, identifying the location of the robot cleaner based on distance between the third electronic device and the robot cleaner, the direction of the robot cleaner and the direction of the charging station with reference to the third electronic device.

15. The method of claim 9, wherein the identifying whether at least one electronic device capable of UWB communication and at least one electronic device capable of wireless communication are present comprises, based on identifying that the location of the robot cleaner is moved, identifying whether the electronic device capable of UWB communication and the electronic device capable of wireless communication are present.

16. The method of claim 9, further comprising,
based on identifying that the location of the charging station is changed, identifying distances between the charging station and the robot cleaner using the UWB communication module while the robot cleaner is located at three different locations; and
identifying the location of the charging station based on the identified distances, and
wherein the three different locations are determined based on accuracy of the distance between the robot cleaner and the charging station identified based on the UWB communication.

17. A non-transitory computer readable recording medium storing computer instructions that cause a robot cleaner to perform an operation when executed by a processor of the robot cleaner, wherein the operation comprises;
identifying whether at least one electronic device capable of UWB communication and at least one electronic device capable of wireless communication are present in a space where the robot cleaner is located;
based on the presence of a first electronic device capable of UWB communication and a second electronic device capable of wireless communication being identified, identifying a first distance between the first electronic device and the robot cleaner using the UWB communication module, identifying a second distance between the second electronic device and the robot cleaner using the wireless communication module;
identifying a third distance between a charging station, located in the space and capable of UWB communication, and the robot cleaner using the UWB communication module; and
identifying the location of the robot cleaner based on the first distance, the second distance, the third distance, the location of the first electronic device, the location of the second electronic device, and the location of the charging station,
wherein the wireless communication includes a communication scheme that is different from the UWB communication.

18. The medium of claim 17, wherein the wireless communication includes a Bluetooth communication.

19. The medium of claim 17, wherein the identifying whether at least one electronic device capable of UWB communication and at least one electronic device capable of wireless communication are present comprises:
based on the first electronic device being an electronic device capable of UWB communication and installed at a fixed location in the place, identifying that the first electronic device is an electronic device capable of the UWB communication, and
based on the second electronic device being an electronic device capable of wireless communication and installed at a fixed location in the place, identifying that the second electronic device is an electronic device capable of the wireless communication.

20. The medium of claim 17, further comprising:
based on identifying that at least two electronic devices capable of wireless communication are present, identifying a distance between each of the at least two electronic devices and the robot cleaner using the wireless communication module; and
identifying the location of the robot cleaner based on the distance between each of the at least two electronic devices and the robot cleaner, the third distance, locations of each of the at least two electronic devices, and the location of the charging station.
